(19) United States
(12) Patent Application Publication
(10) Pub. No.: US 2021/0215997 A1
(43) Pub. Date: Jul. 15, 2021

(54) Retrofit Spying-out Protection

(71) Applicant: Yusuf GÜZEL, Lübbecke (DE)

(72) Inventor: Yusuf GÜZEL, Lübbecke (DE)

(21) Appl. No.: 17/250,110

(22) PCT Filed: May 29, 2019
(86) PCT No.: PCT/DE2019/000152

§ 371 Date: Nov. 30, 2020

(30) Foreign Application Priority Data
May 29, 2018 (DE) 10 2018 112 763.4

(51) Int. Cl. G03B 11/04; G06F 1/16

(52) U.S. Cl. CPC G03B 11/041; G06F 1/1686

(57) ABSTRACT

Implemented is a retrofit spying-out protection of an electronic device, in particular a smartphone, which is provided with a miniature digital camera having a camera lens, composed of a lens cover of a camera lens, which is movable under a film (having a through-recess. Said retrofit spying-out protection insignificantly enlarges the spatial volume of a device and, in addition, can easily be placed in and out of operation, which is achieved in that the film covers the total area of one side of the device and is equipped with an undercut around the edge of the through-recess, said undercut widening towards the surface of the device. The lens cover rests on the surface of the electronic device with a contact surface facing away from the access surface, extends with lateral flattened portions under the undercut and is held in a form-fitting manner on the surface by the film.

### CROSS-REFERENCE TO RELATED APPLICATIONS

This Non-Provisional Utility Patent application claims the benefit of and priority to International Application No. PCT/DE2019/000152, filed May 29, 2019, entitled “Retrofit Spying-out Protection,” which claims the benefit of and priority to German Patent Application No. 10 2018 112 763.4, filed May 29, 2018, entitled “Retrofit Spying-out Protection,” the entire contents of both applications of which are hereby incorporated herein by reference, with a proper claim for priority being made in the Application Data Sheet.

### BACKGROUND

The invention relates to a retrofit spying-out protection on an electronic device provided with a miniature digital camera, such as a communication or entertainment device like a smartphone, a tablet, a notebook or a smart TV, in accordance with the generic concept of the main claim.

It is a case known for electronic devices like a smartphone, DE 20 2016 008 109 U1, which is rigid, with recesses with sliders provided in the walls with which controls or a camera can be locked or covered.

The disadvantage of the known case is, in particular, that the volume of a smartphone equipped with it increases significantly so that it cannot be pushed easily into tight pockets and it can also become unwieldy. In addition, when pushed into a tight garment, it is very bulky, which is visually disadvantageous, and also causes mechanical stress on the garment.

Also known is the covering of the camera lenses of notebooks or smartphones with sections of self-adhesive tape, whereby users ensure that they have a simple means of contact surface (10) rests on the surface of the electronic device and extends with lateral flattened portions (18) under the undercut (16) and is held in place in a form-fitting manner on the surface by the film (3;4), where the undercut (16) in the cross section has a dovetail-shaped contour through the through-recess (6). self-protection available if the high-tech devices provided with cameras are infected with malicious software which allows the operation of the cameras without the knowledge of the user.

The disadvantage of this is that the device is less convenient to use because of the fact that the overlay must be removed to use the camera, which on the one hand can contaminate the housing or the camera lens with adhesive residues and, on the other hand, requires the adhesive tape segment to be replaced with new adhesive strips in order to ensure personal protection from being spied upon again.

### SUMMARY

The object of the invention is therefore to provide a retrofit spying-out protection on an electronic device provided with a miniature digital camera, such as a communication or entertainment device like a smartphone, tablet, notebook or smart TV, which only increases the space volume of the electronic device equipped with it by an insignificant amount and which is also easy to put in and out of operation.

In conjunction with the features of the generic concept of the first patent claim, together with the technical features of its characterising part, the solution to this problem is achieved, in particular, by the lens cover of a camera lens of a miniature digital camera of an electronic communication or entertainment device provided with it being movably mounted under, behind or into a film, the film having a through-recess through which an access surface of the lens cover extends outwards and the lens cover being mounted on the access surface so that it can be moved manually under the film and the film having a contact surface, at least in the area around the camera lens, with which it can be positioned on the surface of the electronic device, and also by the lens cover being designed to be movable in two operating states, namely in a closed position in front of the camera lens and in an opening position next to the camera lens.

The advantage of this film provided with a lens cover is its low thickness dimension of only a few tenths of a millimetre, so that the volume of a smartphone equipped with it increases imperceptibly and the familiar handling of an electronic device equipped with the retrofit spying-out protection does not change.

Furthermore, the access surface on the lens cover allows it to be moved under, behind or into the film, so that, when necessary, the camera lens can be opened again easily and without leaving adhesive residues from a piece of adhesive film on the top of the device which closes the camera lens, or even on the camera lens itself. Equally advantageous is the fact that personal protection against spying can be quickly and easily restored by simply sliding the camera cover back in front of the camera lens.

The advantageous design features of the invention result from and in combination with the following subclaims.

In accordance with the particularly preferred embodiment of the invention, the film is designed as a self-adhesive film so that it can, where necessary, also be removed from an electronic device without leaving any residue. Such an embodiment also makes it possible to use the retrofit spying-out protection on different devices since the strength of the adhesive does not decrease in the long run, and this means that the inventive retrofit spying-out protection can also be used for many years over several generations of electronic devices. However, the use of a film stuck on by an adhesive need not be ruled out and can also be advantageous for a secure fit of the retrofit spying-out protection, in particular for those embodiments which have only a small contact area with the electronic device.

In a plan view the lens cover is preferably designed as a round or elongated sliding piece so that it can be adapted to the most varied of electronic devices in a model-specific manner, thereby creating a virtually universal use of the retrofit spying-out protection.

The through-recess in the film can be straight or curved and the lens cover is designed accordingly to be capable of moving in a straight line or along a curved path, whereby it can also be advantageous to have a version with a lens cover which can be rotated around a vertical axis onto the surface of the electronic device, and as a result the possibility of having executable variants of the inventive retrofit spying-out protection is further multiplied.

In accordance with the particularly preferred embodiment of the invention the lens cover is coloured in an area which is in a closed position in front of the camera lens and the film is also coloured in an area around the camera lens, so that in a closed position both areas complement each other to form a common area as a closed unit or partially overlap each other so that a closed position is visually highlighted as such. For example, a coloured ring can be positioned around the lens area on the film and the lens cover can be provided with an access area of the same or a different colour, which together can either form a larger monochrome circle or, for example, if the access area is black and the lens area blue, they can display in the closed position an eye with a black pupil and a blue iris. The user of the electronic device can quickly and clearly see that, for example, the retrofit spying-out protection is working in a locked position, so that he has to bring this locked position into an open position in order to take photos knowingly with the miniature camera. This effectively prevents incorrect operation of the miniature digital camera.

Such a visual identification of a closed position naturally has, of course, the advantage that the open position is visually highlighted as such with a local separation of the coloured areas, so that a user can also clearly recognise an unprotected position of the miniature camera and restore the closed position when necessary.

In a further advantageous embodiment of the invention, the lens cover can be made opaque or even indistinctly translucent, so that, although light can enter the miniature digital camera, it is, however, so diffuse that no people or objects are visible.

In order to ensure that a lens cover which has been moved into an open position or closed position remains there, an elastic constriction can preferably be formed in the displacement path of the through-recess for locking in both operating states, roughly in the shape of a collar where, alternatively or additionally, the lens cover can also be designed with at least one catch protruding in the direction of the film for locking in both operating states, and where this catch can also be frictionally engaged under the film so that no slot or recess which would negatively affect its stability need be inserted.

A further special advantage of the retrofit spying-out protection is the option of either making the film so small that it stretches tightly around only a partial area of a camera lens or over the entire area of just one side of an electronic device, as if it were part of a display protection film, as it is offered for various smartphones.

Further advantageous refinements of the inventive retrofit spying-out protection include the fact that when mounted on an electronic device, the lens can either protrude with its access surface from the through-recess, or, in another version, is on the same plane as the film or even below it, so that, depending on personal preference, the operation of the retrofit spying-out protection can be simplified or preference can be given to a possibly non-protruding retrofit spying-out protection.

In accordance with the particularly preferred embodiment of the invention, the film around the through-recess can be equipped with a spatially raised embossing in the form of a raised area which creates a free space underneath for the lens cover, whereby the lens cover is slidably mounted into the free space along the through-recess and the lens cover rests on the surface of the electronic device with the contact surface facing away from the access surface and is held in place by the film in a form-fitting manner.

According to another advantageous embodiment of the inventive retrofit spying-out protection, the film around the edge of the through-recess is equipped with an undercut which widens towards the surface of the electronic device. Here too, the lens cover also rests on the surface of the electronic device with the contact surface facing away from the access surface and extends under the undercut with lateral flattened portions which are adapted to the undercut, and is thus also held in place in a form-fitting manner on the surface by the film.

The lens cover here preferably has a height dimension which is equal to the thickness of the film, so that the retrofit spying-out protection does not protrude above the surface of the film, which results in the flattest possible embodiment of the inventive retrofit spying-out protection. The undercut around the through-recess of the film is advantageously equipped with a dovetail-shaped contour in the cross-section, just as the sliding surface of the lens cover can be designed as a flat sloping surface under the spatial embossing, so that between the two a defined interplay of the parallel surfaces or an air gap of about 0.05 mm is generated.

### BRIEF DESCRIPTION OF THE DRAWINGS

Some examples of the embodiments of the invention are described in more detail below with reference to the diagrams. They show:

FIG. 1—a partial view of a retrofit spying-out protection with a spatially raised embossing in a device-covering film,

FIG. 2—a lens cover of a retrofit spying-out protection in accordance with FIG. 1,

FIG. 3—a spatial partial view of the retrofit spying-out protection in accordance with FIG. 1,

FIG. 4—a partial view of a further retrofit spying-out protection in a device-covering film,

FIG. 5—an enlarged side view of a lens cover of the retrofit spying-out protection in accordance with FIG. 4,

FIG. 6—a plan view of the lens cover in accordance with FIG. 5,

FIG. 7—a spatial view of a retrofit spying-out protection in the smallest possible embodiment, accordance with FIG. 7,

FIG. 9—a sectional side view of the retrofit spying-out protection along the line 9-9 in FIG. 8,

FIG. 10—an enlarged partial view of FIG. 9 in cross-section,

FIG. 11—a view from below of a film of a retrofit spying-out protection in accordance with FIGS. 7 to 10,

FIG. 12—a sectional side view of the retrofit spying-out protection along the line 12-12 in FIG. 11, and

FIG. 13—a sectional longitudinal view through the retrofit spying-out protection along the line 13-13 in FIG. 11.

### DETAILED DESCRIPTION

The retrofit spying-out protection on an electronic device provided with a miniature digital camera with a camera lens, such as an electronic communication or entertainment device like a smartphone, tablet, notebook or smart TV, comprises essentially a lens cover 1;2 of a camera lens, which is movably mounted under, behind or into a film 3;4 wherein the film 3;4 has a through-recess 5;6 through which an access surface 7;8 of the lens cover 1;2 extends outwards so that the lens cover 1;2 is mounted on the access surface 7;8 so that it can be moved manually under the film 3;4, wherein the film 3;4 has, at least in a narrow area around the camera lens, a contact surface with which it can be positioned on the surface of an electronic device and the lens cover 1;2 is designed to be movable in two operating states, namely in a closed position in front of the camera lens and in an open position next to the camera lens.

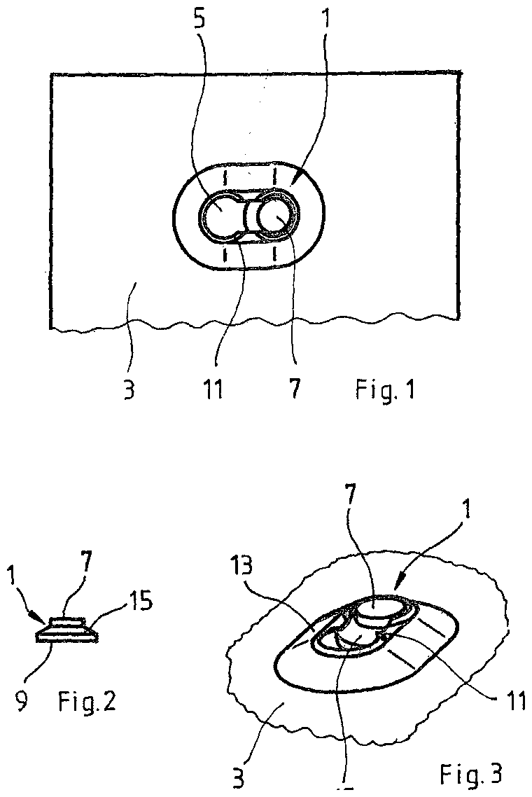

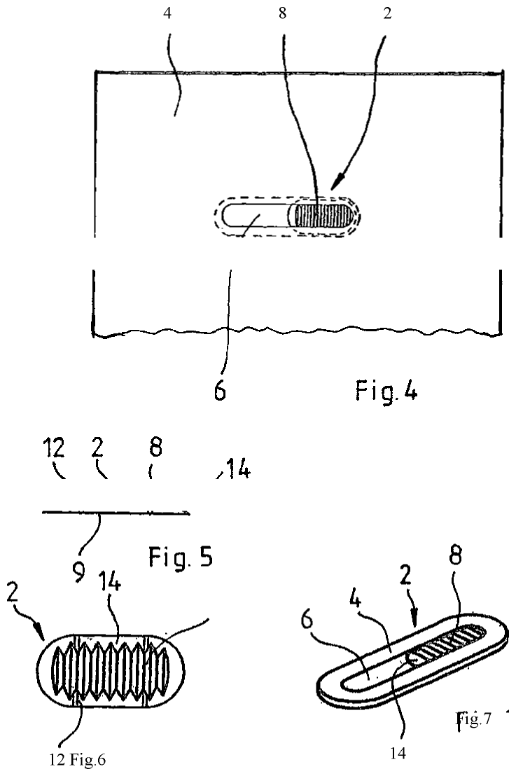

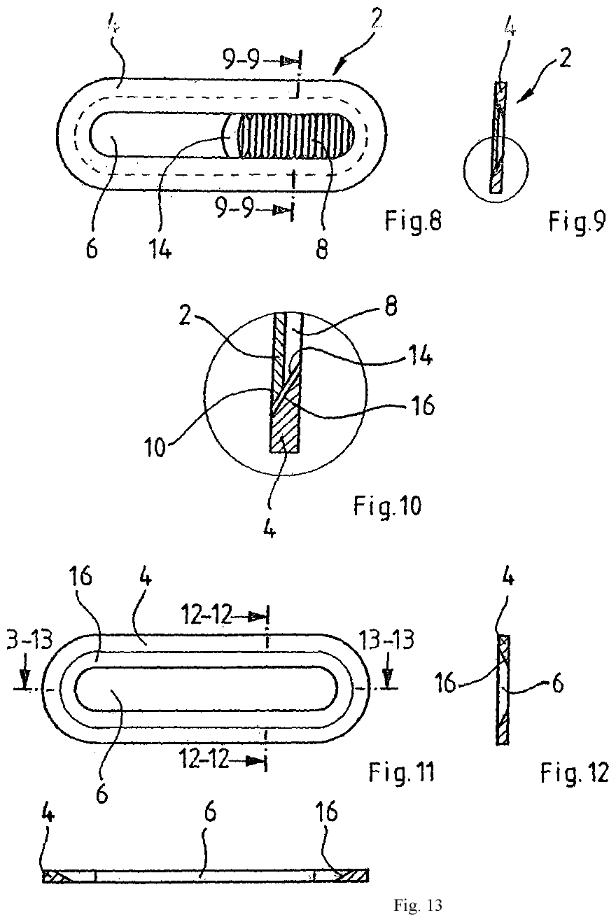

The film 3;4 is designed as a self-adhesive film, so that no adhesive residues can remain on the surface of an electronic device after their removal. The lens cover 1;2, as shown in FIGS. 1 to 3, consists of a sliding piece which in a plan view is round and, as shown in FIGS. 4 to 11, is an elongated sliding piece.

The through-recess 5;6 in the film 3;4 is shown in FIGS. 1, 3, 4, 7, 8, 11, 12, 13, 14 as a straight recess, but it could also be designed in a curved form, which is not shown in the diagrams. The lens cover 1;2 is accordingly designed to be capable of moving along a straight path on the surface of the electronic device, with lens covers which can be rotated around their vertical axis also being possible. These too, however, are not shown in the diagrams.

The lens cover 1;2 can be designed to be opaque or slightly translucent, whereby a translucent lens cover 1;2 is designed to allow only a blurred incidence of light. The lens cover 1;2 can also be coloured in an area in which it lies in front of a camera lens, just as the film 3;4 can be coloured in the area around the camera lens, so that a closed position is visually highlighted.

In the through-recess 5; 6 in the displacement path of the lens cover 1;2, an elastic constriction 11 in the form of a collar is positioned for locking in both the operating states of the retrofit spying-out protection device or the lens cover 1;2 is equipped with a catch 12 protruding in the direction of the film 3;4, which, due to friction, keeps the lens cover 1;2 in one of its two operating states, without having to make catch recesses in the film 3;4.

As indicated in FIGS. 1 and 4, the film 3;4 of the retrofit spying-out protection can cover the entire surface of one side of an electronic device, like a smartphone, and thus be part of a protective film, in the same way that a film 3;4 can cover only a small partial area around a camera lens, as this is possible with a retrofit spying-out protection, which is shown in FIGS. 7 to 13.

In an embodiment not shown in the diagram, the lens cover 1;2 can protrude beyond the plane of the film 3;4 or, as shown in FIGS. 1, 3, 4 and 7, not be designed to protrude beyond the contour of the films 3;4, the lens cover 1; 2 then having a height dimension which is equal to the thickness dimension of the film 3;4

An embodiment of the retrofit spying-out protection, as shown in FIGS. 1 to 3, is equipped with a spatially raised embossing 13 in the film 3 for positioning over a camera lens, where the embossing 13 extends around the through-recess 5, so that a free space with a small clearance of a few hundredths of a millimetre is created for the lens cover 1, into which the lens cover 1 is movably mounted. This rests on the surface of the electronic device with a contact surface 9 facing away from the access surface 7 and is held in place in a form-fitting manner by the film 3 via the lateral sliding surfaces 15 of the lens cover 1. In the border area of the through-recess 5, this is equipped with an elastic constriction 11 in the shape of a collar, which holds the lens cover 1 in place in a form-fitting manner in one of the two functional positions.

The retrofit spying-out protection in accordance with FIGS. 4 to 13 is equipped around the edge of the through-recess 6 with an undercut 16 in the form of a dovetail-shaped contour which widens towards the surface of the electronic device. Here the lens cover 2 with a contact surface 10 facing away from the access surface 8 rests on the surface of the electronic device and has lateral flattened portions 14 which extend under the undercut 16 so that the lens cover 2 is tightly held in place in a form-fitting manner on the surface by the film 4.

1-14. (canceled)

15. A retrofit spying-out protection for an electronic device provided with a miniature digital camera with a camera lens, comprising:
a lens cover, a camera lens, and a film, wherein:
the lens cover is movably mounted under, behind or in the film,
the film has a through-recess through which an access surface of the lens cover extends outwards,
the lens cover is mounted on the access surface so that it can be moved manually under the film,
the film has, at least in an area around the camera lens, a contact surface with which it can be positioned on a surface of the electronic device, and
the lens cover is designed to be movable in two operating states, namely in a closed position in front of the camera lens and in an open position next to the camera lens, wherein:
an elastic constriction is formed in the through-recess in the displacement path of the lens cover for locking in both operating states.

16. A retrofit spying-out protection for an electronic device provided with a miniature digital camera with a camera lens, comprising:
a lens cover, a camera lens, and a film, wherein:
the lens cover is movably mounted under, behind or in the film,
the film has a through-recess through which an access surface of the lens cover extends outwards,
the lens cover is mounted on the access surface so that it can be moved manually under the film,
the film has, at least in an area around the camera lens, a contact surface with which it can be positioned on a surface of the electronic device, and
the lens cover is designed to be movable in two operating states, namely in a closed position in front of the camera lens and in an open position next to the camera lens, wherein:
the film around the through-recess is equipped with a spatial embossing in a form of a raised area which creates a free space underneath for the lens cover and that the lens cover is movably mounted in the free space along the through-recess and that the lens cover rests on the surface of the electronic device with the contact surface facing away from the access surface and is held in place in a form-fitting manner by the film.

17. A retrofit spying-out protection for an electronic device provided with a miniature digital camera with a camera lens, comprising:
a lens cover, a camera lens, and a film, wherein:
the lens cover is movably mounted under, behind or in the film,
the film has a through-recess through which an access surface of the lens cover extends outwards,
the lens cover is mounted on the access surface so that it can be moved manually under the film,
the film has, at least in an area around the camera lens, a contact surface with which it can be positioned on the surface of the electronic device, and
the lens cover is designed to be movable in two operating states, namely in a closed position in front of the camera lens and in an open position next to the camera lens, wherein:
the film is equipped around an edge of the through-recess with an undercut widening towards the surface of the electronic device and the lens cover rests on the surface of the electronic device with the contact surface facing away from the access surface and extends with lateral flattened portions under the undercut and is held in place in a form-fitting manner by the film.

18. The retrofit spying-out protection of claim 15, wherein the film is designed as a film which is self-adhesive or is stuck down with an adhesive.

19. The retrofit spying-out protection of claim 15, wherein the lens cover is designed in a plan view as a round or elongated sliding piece.

20. The retrofit spying-out protection of claim 15, wherein the through-recess is straight or curved and the lens cover is accordingly configured to move in a straight line or along a curved path or is designed to be rotatable around onto the surface of the electronic device.

21. The retrofit spying-out protection of claim 15, wherein the lens cover is coloured in an area which is in a closed position in front of the camera lens and that the film is also coloured in an area around the camera lens and that in a closed position both areas complement each other to form a common area as a closed unit or partially overlap visually so that a closed position is visually highlighted as such.

22. The retrofit spying-out protection of claim 21, wherein in an open position a local separation of the coloured areas is created and the open positions as such are also visually highlighted.

23. The retrofit spying-out protection of claim 22, wherein the lens cover is designed to be opaque or like frosted glass or satin-finished translucent.

24. The retrofit spying-out protection of claim 15, wherein the lens cover is designed with a catch protruding in the direction of the film for locking in both operating states.

25. The retrofit spying-out protection of claim 24, wherein the film covers a partial area around the camera lens or the entire area of one side of the electronic device.

26. The retrofit spying-out protection of claim 25, wherein the lens cover, when mounted on the electronic device with its access surface, protrudes from the through-recess or is formed in a plane with the film or below it.

27. The retrofit spying-out protection of claim 17, wherein the undercut has a dovetail-shaped contour in the cross-section through the through-recess.

28. The retrofit spying-out protection of claim 16, wherein the film is designed as a film which is self-adhesive or is stuck down with an adhesive.

29. The retrofit spying-out protection of claim 16, wherein the lens cover is designed in a plan view as a round or elongated sliding piece.

30. The retrofit spying-out protection of claim 16, wherein the through-recess is straight or curved and the lens cover is accordingly configured to move in a straight line or along a curved path or is designed to be rotatable around onto the surface of the electronic device.

31. The retrofit spying-out protection of claim 16, wherein the lens cover is coloured in an area which is in a closed position in front of the camera lens and that the film is also coloured in an area around the camera lens and that in a closed position both areas complement each other to form a common area as a closed unit or partially overlap visually so that a closed position is visually highlighted as such.

32. The retrofit spying-out protection of claim 31, wherein in an open position a local separation of the coloured areas is created and the open positions as such are also visually highlighted.

33. The retrofit spying-out protection of claim 32, wherein the lens cover is designed to be opaque or like frosted glass or satin-finished translucent.

34. The retrofit spying-out protection of claim 16, wherein the lens cover is designed with a catch protruding in the direction of the film for locking in both operating states.

35. The retrofit spying-out protection of claim 34, wherein the film covers a partial area around the camera lens or the entire area of one side of the electronic device.
